(19) United States
(12) Patent Application Publication
(10) Pub. No.: US 2025/0167876 A1
(43) Pub. Date: May 22, 2025

(54) METHOD AND APPARATUS FOR UE COMMUNICATING WITH TELECOMMUNICATION NETWORK VIA A SATELLITE

(71) Applicant: SAMSUNG ELECTRONICS CO., LTD., Suwon-si, Gyeonggi-do (KR)

(72) Inventors: Mahmoud WATFA, Middlesex (GB); Chadi KHIRALLAH, Middlesex (GB); Lalith KUMAR, Bangalore (IN)

(21) Appl. No.: 18/838,969

(22) PCT Filed: Feb. 17, 2023
(86) PCT No.: PCT/KR2023/002354

§ 371 Date: Aug. 15, 2024

(30) Foreign Application Priority Data
Feb. 17, 2022 (IN) 202231008509

(51) Int. Cl. H04B 7/185; H04L 69/28; H04W 48/16

(52) U.S. Cl. CPC H04B 7/185; H04L 69/28; H04W 48/16

(57) ABSTRACT

The disclosure relates to a 5G or 6G communication system for supporting a higher data transmission rate. Disclosed is a method of operating a User Equipment, UE, the UE communicating with a telecommunication network via a satellite, wherein when a Non-Access Stratum, NAS, timer is determined, any restriction on use of an enhanced coverage indication from the telecommunication network is not considered when the NAS timer is determined.

### TECHNICAL FIELD

The present disclosure relates to satellite access to a telecommunication network.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

An embodiment of the present disclosure provides a method of operating a User Equipment UE, the UE communicating with a telecommunication network via a satellite, the method may comprise identifying that the UE is in communication with the telecommunication network via a satellite, and determining a value of a non-access stratum, NAS, timer for 5GS mobility management. Wherein, when the NAS timer is determined, any restriction on use of an enhanced coverage indication from the telecommunication network is not considered when the NAS timer is determined.

An embodiment of the present disclosure provides an apparatus arranged to perform the method. The apparatus may comprise at least one of a telecommunication network and a UE, each comprising a processor, a transceiver, and a memory.

### BRIEF DESCRIPTION OF DRAWINGS

For a better understanding of the disclosure, and to show how embodiments of the same may be carried into effect, reference will now be made, by way of example only, to the accompanying diagrammatic drawings in which:

FIG. 1 shows a system architecture illustrating an embodiment of the disclosure;

FIG. 2 shows a flowchart illustrating a mode in operation of an embodiment of the present disclosure; and

FIG. 3 shows a block diagram illustrating an embodiment of the disclosure.

### MODE FOR THE INVENTION

In embodiments of the present disclosure, a UE (e.g., UE 10) may support both N1 mode and S1 mode. As such, if the network supports interworking between 5GS (5G system) (referred to as N1 mode) and EPS (evolved packet system) (referred to as S1 mode), then PDU sessions can be transferred between 5GS and EPS.

Non-access stratum, NAS, timers are extended in certain modes of operation as described in 3GPP TS 24.301. For example, coverage enhancement can lead to extending NAS timers if the network indicates that this is not restricted. This is shown below from 3GPP TS 24.301:

“In WB-S1 (wideband S1) mode, a User Equipment, UE, operating in category CE (coverage enhancement) can operate in either CE mode A or CE mode B (see 3GPP TS 36.306 [44]). If a UE that supports CE mode B and operates in WB-S1 mode the UE's usage setting is not set to “voice centric” (see 3GPP TS 23.401), and
a) the use of enhanced coverage is not restricted for the UE; or
b) CE mode B is not restricted for the UE (see 3GPP TS 23.401);
the UE shall apply the value of the applicable NAS timer indicated in tables 10.2.1 and indicated in table 10.3.1 for WB-S1/CE mode.

A UE that supports CE mode B and operates in WB-S1 mode shall not apply the value of the applicable NAS timer indicated in table 10.2.1 and table 10.3.1 for WB-S1/CE mode before receiving an indication from the network that the use of enhanced coverage is not restricted as described in this clause.

The NAS timer value obtained is used as described in the appropriate procedure clause of this specification. The NAS timer value shall be calculated at start of a NAS procedure, and shall not be re-calculated until the NAS procedure is completed, restarted or aborted.

The support of CE mode B by a UE is indicated to the MME (mobility management entity) by lower layers and shall be stored by the MME. When an MME that supports WB-S1 mode performs NAS signalling with a UE, which supports CE mode B and operates in WB-S1 mode and the MME determines that
a) the use of enhanced coverage is not restricted for the UE; or
b) CE mode B is not restricted for the UE (see 3GPP TS 23.401)
the MME shall calculate the value of the applicable NAS timer indicated in tables 10.2.2 and indicated in table 10.3.2 for WB-S1/CE mode.

The NAS timer value obtained is used as described in the appropriate procedure clause of this specification. The NAS timer value shall be calculated at start of a NAS procedure and shall not be re-calculated until the NAS procedure is completed, restarted or aborted.”

Similar text can be found in 3GPP TS 24.501 for 5GS:

“In WB-N1 mode, a UE operating in category CE can operate in either CE mode A or CE mode B (see 3GPP TS 36.306 [25D]). If a UE that supports CE mode B and operates in WB-N1 mode and the UE's usage setting is not set to “voice centric” (see 3GPP TS 23.501), and:
a) the use of enhanced coverage is not restricted by the network; or
b) CE mode B is not restricted by the network (see 3GPP TS 23.501);
the UE shall apply the value of the applicable NAS timer indicated in table 10.3.1 for WB-N1/CE mode.

A UE that supports CE mode B and operates in WB-N1 mode shall not apply the value of the applicable NAS timer indicated in table 10.3.1 for WB-N1/CE mode before receiving an indication from the network that the use of enhanced coverage is not restricted, or CE mode B is not restricted, as described in this subclause.

The NAS timer value obtained is used as described in the appropriate procedure subclause of this specification. The NAS timer value shall be calculated at start of a NAS procedure, and shall not be re-calculated until the NAS procedure is completed, restarted or aborted.

If the use of extended NAS timer is indicated by the AMF (access and mobility management function) (see 3GPP TS 23.501 and 3GPP TS 23.502), the SMF (session management function) shall calculate the value of the applicable NAS timer indicated in table 10.3.2 for WB-N1/CE mode.

The NAS timer value obtained is used as described in the appropriate procedure subclause of this specification. The NAS timer value shall be calculated at start of a NAS procedure and shall not be re-calculated until the NAS procedure is completed, restarted or aborted.”

Work is ongoing in relation to NAS timer extensions for satellite access. At least one problem is known in the prior art. Firstly, unclear behaviour can be experienced in the UE in relation to extending NAS timer during satellite access.

There are suggestions that NAS timers needs to be extended when the UE uses satellite access, seemingly by default. However, NAS timer extension for satellite creates an unclear UE behaviour when the RestrictEC bit(s) (in the Evolved Packet System, EPS, network feature support Information Element, IE, (3GPP TS 24.301), or the 5GS network feature support (3GPP TS 24.501)) is set to different values. Note that in EPS, the field is 1 bit long. In 5GS, the field is 2 bits long.

In EPS, the bit position may take the following values in the EPS network feature support IE as shown in the table 1 below.

TABLE 1
Restriction on enhanced coverage (RestrictEC) (octet 4, bit 5)
This bit indicates if the use of enhanced coverage is restricted or not.

| Bit | |
|---|---|
| 5 | |
| 0 | Use of enhanced coverage is not restricted |
| 1 | Use of enhanced coverage is restricted |

In 5GS, the bits may take the following values in the 5GS network feature support IE as shown in the table 2 below.

TABLE 2
Restriction on enhanced coverage (RestrictEC) (octet 4, bit 3 and bit 4)
These bits indicate enhanced coverage restricted information.
In WB-N1 mode these bits are set as follows:

Bits

| 3 | 4 | |
|---|---|---|
| 0 | 0 | Both CE mode A and CE mode B are not restricted |
| 0 | 1 | Both CE mode A and CE mode B are restricted |
| 1 | 0 | CE mode B is restricted |
| 1 | 1 | Reserved |

For example, assume that the UE gets the bit in EPS such that the value is 1 i.e. “Use of enhanced coverage is restricted”. According to the prior art standard specification, the UE must not apply extended timers. However, if the UE is actually engaged in satellite access, then the timer is supposed to be extended. As such, contradictory requirements are experienced where, by default, the satellite access requires timer extension whereas the network may actually indicate that the feature for enhanced coverage is restricted, which according to the prior art specification leads to no NAS timer extension.

It is an aim of embodiments of the present disclosure to address shortcoming, and others, in the prior art.

According to a first aspect of the present disclosure there is provided a method of operating a User Equipment UE, the UE communicating with a telecommunication network via a satellite, wherein when a Non-Access Stratum, NAS, timer is determined, any restriction on use of an enhanced coverage indication from the telecommunication network is not considered when the NAS timer is determined.

In an embodiment, the UE is operable with one of an Evolved Packet System, EPS, or Fifth Generation, 5GS, network.

In an embodiment, if the UE is utilising satellite access, a value associated with a RestrictEC bit is ignored when the NAS timer is determined.

In an embodiment, the telecommunication network sets the RestrictEC bit is set to “1” to indicate an extended NAS timer is in use.

In an embodiment, if the UE is not currently communicating with the telecommunication network via the satellite then the enhanced coverage indication from the telecommunication network is considered when the NAS timer is determined.

According to a second aspect of the present disclosure there is provided an apparatus arranged to perform the method of the first aspect.

In an embodiment, the apparatus comprises at least a telecommunication network and a UE.

According to the present disclosure there is provided an apparatus and method as set forth in the appended claims. Other features of the disclosure will be apparent from the dependent claims, and the description which follows.

Although a few preferred embodiments of the present disclosure have been shown and described, it will be appreciated by those skilled in the art that various changes and modifications might be made without departing from the scope of the disclosure, as defined in the appended claims.

For a better understanding of the disclosure, and to show how embodiments of the same may be carried into effect, reference will now be made, by way of example only, to the accompanying diagrammatic drawings in which:

Embodiments of the present disclosure are provided in a network-based approach and a UE-based approach.

The first embodiment is a network-based solution.

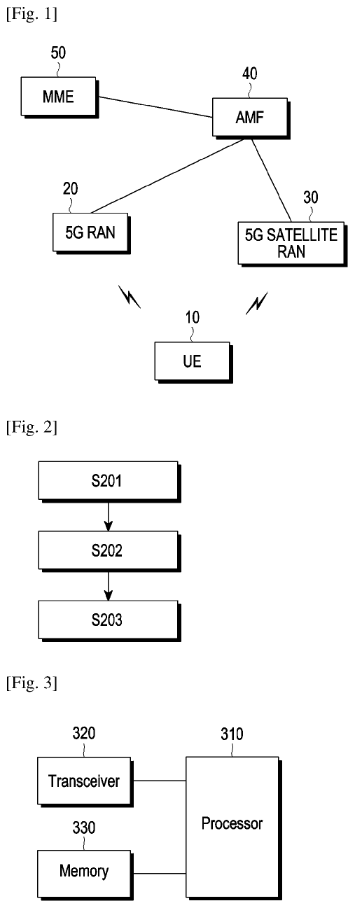

FIG. 1 shows a system architecture illustrating an embodiment of the disclosure.

Referring to FIG. 1, the UE (e.g., an internet of things, IoT, device) may be configured to communicate with a network (e.g. 5G radio access network (RAN) 20 or 5G satellite RAN 30). to address the problem that was identified above, the network (e.g., Mobility Management Entity, MME, 50 or Access and Mobility Management Function, AMF, 40) may behave as follows, optionally for a UE 10 which indicates ‘Restriction on use of enhanced coverage supported’ for the Restriction on use of enhanced coverage support (RestrictEC) bit of the UE network capability IE in S1 mode (i.e. EPS), or in the 5GMM (5G mobility management) capability IE in N1 mode (i.e. 5GS), and/or optionally for a UE which is using satellite access.

The network (e.g. MME 50), may always set the RestrictEC bit of the EPS network feature support IE to the value “0” i.e. to indicate “Use of enhanced coverage is not restricted”. In this case, the use of satellite access which requires NAS timer extension will be in agreement with the RestrictEC bit in the NAS IE.

Note that this also applies to 5GS where the network (e.g. AMF 40), may always set the RestrictEC bits of the 5GS network feature support IE to the value “00” i.e. to indicate “Both CE mode A and CE mode B are not restricted”. In this case, the use of satellite access which requires NAS timer extension will be in agreement with the RestrictEC bits in the NAS IE.

In general, when the UE 10 is using satellite access (e.g., 5G satellite random access network, RAN, 30), the necessary bit(s) (e.g. RestrictEC) in the relevant IEs (as listed above) may be set to a value that would require the NAS timer to be extended. As such, the value indicated by the network may be in agreement the need to extend the NAS timer due to satellite access with, by taking the relevant value.

Note that the above may be implemented by a network whenever the UE is using satellite access. Moreover, the network may behave as described above even if the network does not support the feature (i.e. even when the coverage enhancement feature is not supported by the network) or even if the UE subscription indicates that the use of enhanced coverage is restricted for the UE (or that CE mode A and/or CE mode B is restricted for the UE). Hence, the network may override the actual value of the bit(s) such that the bit(s) is always set to indicate that “Use of enhanced coverage is not restricted” in EPS (or to indicate “Both CE mode A and CE mode B are not restricted” in 5GS), where this is done when the/for a UE that uses satellite access (even when the value of bit(s) may actually indicate otherwise either due to network not supporting the feature or due to the UE subscription indicating that the feature is restricted for the UE)

As such, the network may stop the overriding method/behaviour for the indicated bit(s) as described above whenever the UE is not using satellite access. As such, the determination to override the actual/true value of the bit(s) may consider the type of access that the UE is using as explained above

The second embodiment is a UE-based solution.

In this embodiment, when the UE (e.g., the UE 10) is using satellite access (e.g., 5G satellite RAN 30), the UE may ignore the value of the RestrictEC bit in the EPS network feature support IE (in S1 mode), or the UE may ignore the values of the RestrictEC bits in the 5GS network feature support IE (in N1 mode).

When the UE is using satellite access, the UE may always consider the RestrictEC bit in the EPS network feature support IE (in S1 mode) to indicate “Use of enhanced coverage is not restricted”. This may be done even if the value of the bit indicates otherwise.

When the UE is using satellite access, the UE may always consider the RestrictEC bits in the 5PS network feature support IE (in N1 mode) to indicate “Both CE mode A and CE mode B are not restricted”. This may be done even if the actual value of the bits indicates otherwise.

The UE may behave as described above only when using satellite access (e.g., 5G satellite RAN 30).

When not using the satellite access, the UE does not behave as described above regarding the RestrictEC bit in the EPS network feature support IE in S1 mode, or regarding the RestrictEC bits in the 5PS network feature support IE in N1 mode. As such, when the UE is not using satellite access, the UE treats the bit that is indicated herein according to its true value that is received i.e. the value is not ignored or not considered to be different from its true value in this case.

As such, based on the above, the UE may determine to ignore the bit value as explained above based on the access type that is being used. Note that the ignoring of the bit(s) value may also be considered as a form of overriding the value of the bit(s) to always indicate that coverage enhancement is not restricted (or CE mode A and CE mode B are not restricted). As such, the UE stops ignoring the value of the bit(s) when the UE is not on satellite access.

Therefore, the UE decision to ignore the bit (or to consider the bit to always be set to a specific value, even though that may not truly be the case, as described above) may be based on the access type of the UE e.g. satellite access.

Note that the above applies for both S1 mode and N1 mode. Moreover, the proposals apply for the UE and the network which can be an MME or AMF. The above can be applied in any order or combination.

Note that the value “the use of enhanced coverage is not restricted by the network” can also be applicable to 5GS and, as such, the proposals herein may not be limited to the value of “Both CE mode A and CE mode B are not restricted” in 5GS. Similarly, the values defined in 5GS may also apply in EPS in a similar manner/usage.

Optionally, the network behaves as described above for a UE which indicates that it supports restriction on enhanced coverage in the necessary NAS IE.

Note that the above may be applicable for any type of satellite access or may be applied when specific satellite types are being used e.g. Low Earth Orbit (LEO), Medium Earth Orbit (MEO), Geostationary Orbit (GEO) etc.

For completeness, FIG. 2 shows a flowchart illustrating a mode in operation of an embodiment of the present disclosure.

Referring to FIG. 2, at step S201, a UE (e.g., UE 10) may be in communication with a telecommunication network (e.g., 5G satellite RAN 30, AMF 40, or MME 50) via a satellite. At step S202, a Non-Access Stratum, NAS, timer may be determined, noting, at S203, an enhanced coverage indication from the telecommunication network may be not considered when the NAS timer is determined.

In an embodiment, the UE may identify that the UE is in communication with the telecommunication network via a satellite and determine a value of a non-access stratum, NAS, timer for 5GS mobility management.

FIG. 3 shows a block diagram illustrating an embodiment of the disclosure.

Referring to FIG. 3, the UE 10 or the network (e.g., AMF 40 or MME 50) may comprise at least one of a processor 310, a transceiver 320, or a memory 330, configured to perform at least one the embodiments of the present disclosure.

In an embodiment, the UE (e.g., the processor 310) may obtain (e.g., receive via the transceiver 320) an enhanced coverage indication (e.g., a RestrictEC bit) to determine the value of the NAS timer. In an embodiment, the UE (e.g., the processor 310) may ignore the RestrictEC bit to determine the value of the NAS timer. IN an embodiment, the network (e.g., the processor 310 of AMF 40 or MME 50) may transmit the RestrictEC bit to the UE.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1.-7. (canceled)

8. A method of operating a user equipment (UE), the UE communicating with a communication network via a satellite, the method comprising:
identifying that the UE is in communication with the communication network via a satellite; and
receiving, from the communication network, first information indicating about enhanced coverage of the satellite,
wherein the received first information is not considered in determining a value of a non-access stratum (NAS) timer.

9. The method of claim 8, wherein the value of NAS timer is determined based on a type of satellite access.

10. The method of claim 8, wherein the first information is reset to have a specific value, and
wherein the value of NAS timer is determined based on at least one of a type of satellite access or the reset first information.

11. The method of claim 8, wherein the first information comprises a RestrictEC information element (IE) which is represented by a bit or two bits.

12. The method of claim 8, wherein the communication network comprises an evolved packet system (EPS) or fifth generation (5GS) network.

13. The method of claim 8, wherein the NAS timer is determined as an extended NAS timer.

14. A user equipment (UE) communicating with a communication network via a satellite, the UE comprising:
a transceiver; and
a processor configured to:
identify that the UE is in communication with the communication network via a satellite; and
receive, from the communication network, first information indicating about enhanced coverage of the satellite,
wherein the received first information is not considered in determining a value of a non-access stratum (NAS) timer.

15. The UE of claim 14, wherein the value of NAS timer is determined based on a type of satellite access.

16. The UE of claim 14, wherein the first information is reset to have a specific value, and
wherein the value of NAS timer is determined based on at least one of a type of satellite access or the reset first information.

17. The UE of claim 14, wherein the first information comprises a RestrictEC information element (IE) which is represented by a bit or two bits.

18. The UE of claim 14, wherein the communication network comprises an evolved packet system (EPS) or fifth generation (5GS) network.

19. The UE of claim 14, wherein the NAS timer is determined as an extended NAS timer.

20. A method of operating a communication network, the communication network communicating with user equipment (UE) via a satellite, the method comprising:
generating, first information indicating about enhanced coverage of the satellite; and
transmitting, to the UE, the first information indicating about enhanced coverage of the satellite.

21. The method of claim 20, wherein first information indicating is determined by the communication network.

22. The method of claim 20, wherein the first information is reset to have a specific value.

23. The method of claim 20, wherein the first information comprises a RestrictEC information element (IE) which is represented by a bit or two bits.

24. The method of claim 20, wherein the communication network comprises an evolved packet system (EPS) or fifth generation (5GS) network.
